(19) United States
(12) Patent Application Publication
(10) Pub. No.: US 2020/0344286 A1
(43) Pub. Date: Oct. 29, 2020

(54) METHOD AND APPARATUS FOR OPERATING DYNAMIC NETWORK SERVICE ON THE BASIS OF LATENCY

(71) Applicant: Center of Human-Centered Interaction for Coexistence, Seoul (KR)

(72) Inventors: Tae Young LEE, Seoul (KR); Eun Mi LEE, Seoul (KR); Jae Heung SURH, Seoul (KR); Joong Jae LEE, Seoul (KR); Bum Jae YOU, Seoul (KR)

(21) Appl. No.: 16/563,591

(22) Filed: Sep. 6, 2019

(30) Foreign Application Priority Data
Apr. 26, 2019 (KR) 10-2019-0049152

(51) Int. Cl. H04L 29/06; H04L 12/851; H04L 12/841

(52) U.S. Cl. CPC H04L 65/80; H04L 47/283; H04L 47/24; H04L 65/608

(57) ABSTRACT

Provided is a method for operating a dynamic network service on the basis of latency. A method for operating a dynamic network service on the basis of latency according to an exemplary embodiment of the present disclosure includes receiving a required latency corresponding to a latency required for operating a service in which at least one type of data among video data, voice data, and sensor data is provided to a user over a network; profiling latency information which is information on a latency related to each of a plurality of detailed modules to be used for operating the service while the service is operating; and changing a configuration for at least one of the plurality of detailed modules so as to correspond to the required latency on the basis of the profiling result.

### CROSS-REFERENCE TO RELATED APPLICATIONS

This application claims the priority of Korean Patent Application No. 10-2019-0049152 filed on Apr. 26, 2019, in the Korean Intellectual Property Office, the disclosure of which is incorporated herein by reference.

### BACKGROUND

### Field

The present disclosure relates to a method of synchronizing media data serviced over a network, and more particularly, to a method and an apparatus for dynamically operating a network service using media data on the basis of latency.

### Description of the Related Art

With the development of networks and codecs, the age has come where people can watch movies and TV shows at home using high-capacity VOD, and freely conduct remote video conferences with various applications. This is because it is possible to transmit large amounts of video and audio data in real time. Recently, there is an increasing demand for user interaction using various types of data (3D model, haptic, motion, physics, and the like) obtained from multiple sensors in order to provide not only conventional media data such as video and audio but also various users' interactions, and there is also a growing interest in media synchronization technology to support this.

Particularly, in media synchronization, importance of a method of guaranteeing the quality of experience (QoE) of the user with a real-time transmission method of high-quality large-capacity data has been emphasized. In this respect, it is necessary e to provide real-time data transfer and synchronization policies that are consistent with the services provided.

However, in a conventional media synchronization method, since the method focuses on transmission of data rather than considering various latency factors that may occur in the media transmission process, there is a tendency that the quality of experience (QoE) of the user deteriorates according to the available service limit and the providing environment. As a result, the types of media that can be used in real time are limited, which may make diversification of service contents difficult.

Accordingly, the present disclosure proposes a method and an apparatus for dynamically adjusting and operating a network service using media data on the basis of latency in order to meet the requirements of a service to be provided.

As a related prior art, there is Korean Patent Registration No. 10-0584394 (Title of Invention: Vocoder parameter control method based on real-time network monitoring).

### SUMMARY

An object of the present disclosure is to provide a method and an apparatus for operating dynamically a network service using media data on the basis of latency.

The objects to be solved by the present disclosure are not limited to the aforementioned object(s), and other object(s), which are not mentioned above, will be apparent to those skilled in the art from the following description.

According to an aspect of the present disclosure, there is provided a method for operating a dynamic network service on the basis of latency. The method for operating a dynamic network service on the basis of latency includes: receiving a required latency corresponding to a latency required for operating a service in which at least one of video data, voice data, and sensor data is provided to a user over a network; profiling latency information which is information on a latency related to each of a plurality of detailed modules to be used for operating the service while the service is operating; and changing a configuration for at least one of the plurality of detailed modules so as to correspond to the required latency on the basis of the profiling result.

Preferably, the service may be performed by collecting at least one type of data by a providing device and transmitting the collected data over the network and receiving at least one piece of the transmitted data by a receiving device to provide the received data to the user.

Preferably, the plurality of detailed modules may include a capture module for capturing the at least one type of data by the providing device and a transmission module for transmitting the captured at least one type of data over the network, and a reception module for receiving the transmitted at least one type of data by the receiving device over the network, and a service module for providing the received at least one type of data to the user.

Preferably, the plurality of detailed modules may include a capture module for capturing the at least one type of data by the providing device, an encoding module for encoding the captured at least one type of data, and a transmission module for transmitting the encoded at least one type of data over the network, and a reception module for receiving the transmitted at least one type of data by the receiving device over the network, a decoding module for decoding the received at least one type of data, and a service module for providing the decoded at least one type of data to the user.

Preferably, the plurality of detailed modules may include a capture module for capturing at least one type of data by the providing device, a first synchronization module for first synchronizing the captured at least one type of data, and a transmission module for transmitting the first synchronized at least one type of data over a network, and a reception module for receiving the transmitted at least one type of data over the network by the receiving device, a second synchronization module for second synchronizing the received at least one type of data, and a service module for providing the second synchronized at least one type of data to the user.

Preferably, the plurality of detailed modules may include a capture module for capturing at least one type of data by the providing device, an encoding module for encoding the captured at least one type of data, a first synchronization module for first synchronizing the encoded at least one type of data, and a transmission module for transmitting the first synchronized at least one type of data over a network, and a reception module for receiving the transmitted at least one type of data over the network by the receiving device, a decoding module for decoding the received at least one type of data, a second synchronization module for second synchronizing the decoded at least one type of data, and a service module for providing the second synchronized at least one type of data to the user.

Preferably, in the changing of the configuration for at least one of the plurality of detailed modules, a configuration for at least one of a data capture cycle of the capture module and a size of the captured data may be changed in association with the latencies of the transmission module and the reception module.

Preferably, in the changing of the configuration for at least one of the plurality of detailed modules, a configuration for at least one of a codec type, a loss, a resolution, a frame rate, and a bit rate may be changed in association with the latencies of the encoding module and the decoding module.

Preferably, in the changing of the configuration for at least one of the plurality of detailed modules, a configuration for at least one of a delay, a time compensation cycle, and an output cycle may be changed in association with the latencies of the first synchronization module and the second synchronization module.

Preferably, the sensor data may include at least one of 3D modeling data, haptic data, motion data, and physical data.

According to another aspect of the present disclosure, there is provided an apparatus for operating a dynamic network service on the basis of latency. The apparatus for operating a dynamic network service on the basis of latency includes: an input unit configured to receive a required latency corresponding to a latency required for operating a service in which at least one of video data, voice data, and sensor data is provided to a user over a network; a profiling unit configured to profile latency information which is information on a latency related to each of a plurality of detailed module to be used for operating the service while the service is operating; and a configuration unit configured to change a configuration for at least one of the plurality of detailed modules so as to correspond to the required latency on the basis of the profiling result.

Preferably, the service may be performed by collecting at least one piece of data by a providing device and transmitting the collected data through the network and receiving at least one piece of the transmitted data by a receiving device to provide the received data to the user.

Preferably, the plurality of detailed modules may include a capture module for capturing the at least one type of data by the providing device and a transmission module for transmitting the captured at least one type of data over the network, and a reception module for receiving the transmitted at least one type of data by the receiving device over the network, and a service module for providing the received at least one type of data to the user.

Preferably, the plurality of detailed modules may include a capture module for capturing the at least one type of data by the providing device, an encoding module for encoding the captured at least one type of data, and a transmission module for transmitting the encoded at least one type of data over the network, and a reception module for receiving the transmitted at least one type of data by the receiving device over the network, a decoding module for decoding the received at least one type of data, and a service module for providing the decoded at least one type of data to the user.

Preferably, the plurality of detailed modules may include a capture module for capturing at least one type of data by the providing device, a first synchronization module for first synchronizing the captured at least one type of data, and a transmission module for transmitting the first synchronized at least one type of data over a network, and a reception module for receiving the transmitted at least one type of data over the network by the receiving device, a second synchronization module for second synchronizing the received at least one type of data, and a service module for providing the second synchronized at least one type of data to the user.

Preferably, the plurality of detailed modules may include a capture module for capturing at least one type of data by the providing device, an encoding module for encoding the captured at least one type of data, a first synchronization module for first synchronizing the encoded at least one type of data, and a transmission module for transmitting the first synchronized at least one type of data over a network, and a reception module for receiving the transmitted at least one type of data over the network by the receiving device, a decoding module for decoding the received at least one type of data, a second synchronization module for second synchronizing the decoded at least one type of data, and a service module for providing the second synchronized at least one type of data to the user.

Preferably, the configuration unit may change a configuration for at least one of a data capture cycle of the capture module and a size of the captured data in association with the latencies of the transmission module and the reception module.

Preferably, the configuration unit may change a configuration for at least one of a codec type, a loss, a resolution, a frame rate, and a bit rate in association with the latencies of the encoding module and the decoding module.

Preferably, the configuration unit may change a configuration for at least one of a delay, a time compensation cycle, and an output cycle in association with the latencies of the first synchronization module and the second synchronization module.

Preferably, the sensor data may include at least one of 3D modeling data, haptic data, motion data, and physical data.

According to the present disclosure, it is possible to dynamically determine and operate a configuration of each detailed module so as to correspond to latency requirements of a network service to be provided by profiling latency of detailed modules to be used for the network service using media data.

Further, it is possible to establish and apply a QoI or QoE policy to a service of a network-based VR and AR application programs which provides interaction to a user using heterogeneous and multiple sets of media data.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a flowchart for describing a method for operating a dynamic network service on the basis of latency according to an exemplary embodiment of the present disclosure;

FIGS. 2 and 3 are views for describing a network structure for providing a service and a detailed module used for performing a service according to an exemplary embodiment of the present disclosure;

FIG. 4 is a view for describing a change result of a module configuration according to an exemplary embodiment of the present disclosure;

FIG. 5 is a view for describing a configuration method for each module according to a latency according to an exemplary embodiment of the present disclosure;

FIG. 6 is a view for describing a synchronization level required by a type of service; and

FIG. 7 is a block view for describing an apparatus for operating a dynamic network service on the basis of latency according to an exemplary embodiment of the present disclosure.

### DETAILED DESCRIPTION OF THE PREFERRED EMBODIMENT

The present disclosure may have various modifications and various embodiments and specific embodiments will be illustrated in the drawings and described in detail in the detailed description. However, this does not limit the present disclosure to specific embodiments, and it should be understood that the present disclosure covers all the modifications, equivalents, and replacements included within the idea and technical scope of the present disclosure. In describing each drawing, reference numerals refer to like elements.

Terms including first, second, A, B, and the like are used for describing various constituent elements, but the constituent elements are not limited by the terms. The terms are used only to discriminate one constituent element from another component. For example, a first component may be referred to as a second component, and similarly, the second component may be referred to as the first component. The term ‘and/or’ includes a combination of a plurality of associated disclosed items or any item of the plurality of associated disclosed items.

It should be understood that when it is described that a component is “connected to” or “accesses” another component, the component may be directly connected to access the other component or a third component may be present therebetween. In contrast, it should be understood that when it is described that an element is “directly connected to” or “directly access” another element, it is understood that no element is present between the element and another element.

Terms used in the present application are used only to describe specific embodiments and are not intended to limit the present disclosure. A singular form may include a plural form if there is no clearly opposite meaning in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

If not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art and are not interpreted as an ideal meaning or excessively formal meanings unless clearly defined in the present application.

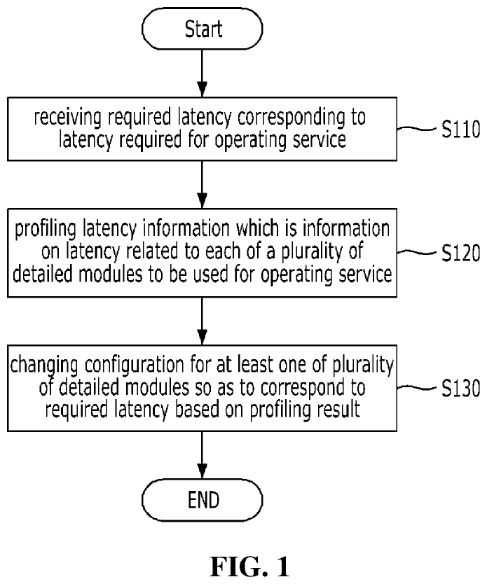

FIG. 1 is a flowchart for describing a method for operating a dynamic network service on the basis of latency according to an exemplary embodiment of the present disclosure.

In step S110, an apparatus for operating a dynamic network service receives a required latency corresponding to a latency required for operating a service in which at least one type of data among video data, voice data, and sensor data is provided to a user over a network.

Here, the service provided to the user may be a VOD service for movies and dramas including video data and voice data, an online video conferencing service, or the like. Furthermore, the service may be augmented reality (AR), virtual reality (VR), mixed reality (MR), and coexistence reality (CR) services that further include sensor data that provides various interactions of the user with the video data and the voice data. However, the service of the present disclosure is not limited thereto and may be various types of services for providing services in relation to at least one of video data, voice data, and sensor data.

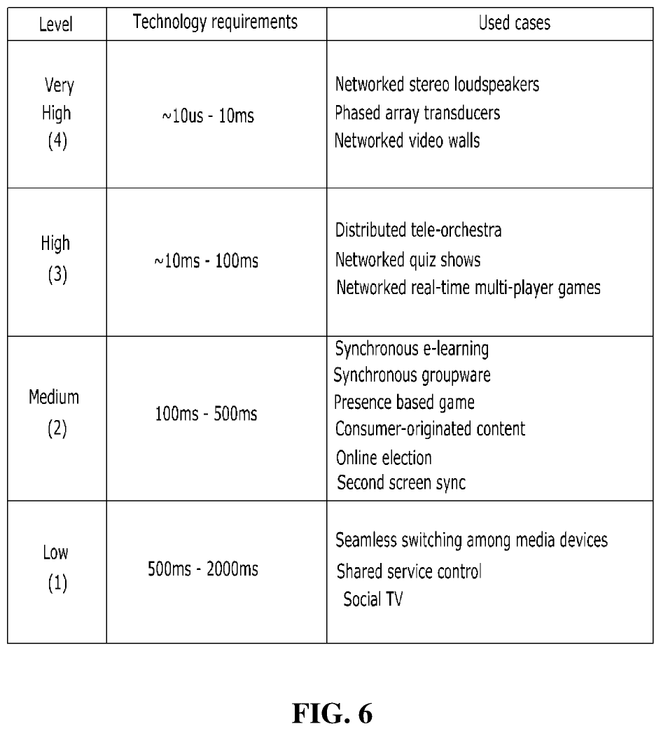

On the other hand, the apparatus for operating the dynamic network service may receive a required latency related to a latency suitable for operating a specific service. For example, the apparatus for operating the dynamic network service may receive a request delay time related to the specific service from a service operator. Referring to FIG. 6, exhibited are technical requirements (that is, latency) suitable for operating a service for various use cases.

More specifically, the apparatus for operating the dynamic network service may receive a specific latency value as the required latency or may receive one of a predetermined number of steps as the required latency. At this time, the required latency may be in a range of a latency suitable for a specific service. For example, the apparatus for operating the dynamic network service may receive a required latency of 10 ms to 100 ms to provide a distributed remote orchestra service.

In another exemplary embodiment, the sensor data may include at least one of 3D modeling data, haptic data, motion data, and physical data.

For example, the 3D modeling data may be 3D modeling data for an indoor or outdoor space, the haptic data may be vibration data provided to the user, the motion data may be data representing the motion of the user, and the physical data may be data including a result of simulating a pose of an object using a physical engine.

As such, the apparatus for operating the dynamic network service can provide various and rich network services to the users by using the various sensor data.

In step S120, while the service operating, the apparatus for operating the dynamic network service profiles latency information, which is information on the latency associated with each of a plurality of detailed modules to be used for the service operation.

That is, the apparatus for operating the dynamic network service may capture and profile latency information for each of a plurality of detailed modules to be used for the operation of the service.

For example, in the case where the detailed modules used for the operation of the service are three modules, that is, an encoding module, a decoding module, and a synchronization module, the apparatus for operating the dynamic network service measures latency which is a time required for a repeated unit work for operating the service for each of the three modules to profile the latency information.

In another exemplary embodiment, the service may be performed by collecting at least one type of data by a providing device and transmitting the collected data over the network and receiving at least one piece of the transmitted data by a receiving device to provide the received data to the user.

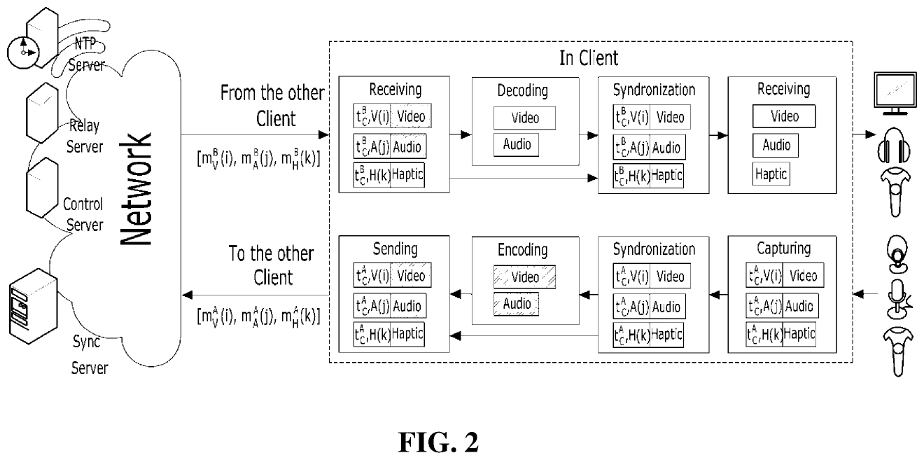

For example, referring to FIG. 2, the providing device may capture, synchronize, and encode at least one type of data using a camera, a microphone, or a vibration sensor, and then send the data over the network. In addition, the receiving device may receive, decode, synchronize, and then render at least one type of data over the network to provide the data to the user. At this time, it will be apparent to those skilled in the art that the synchronization and encoding of the providing device and the decoding and synchronization of the receiving device may be performed selectively.

Herein it goes without saying that the encoding and decoding processes may be selectively performed depending on the type of data and the need.

In yet another exemplary embodiment, the plurality of detailed modules may include a capture module for capturing at least one type of data by the providing device, an encoding module for encoding the captured at least one type of data, a first synchronization module for first synchronizing the encoded at least one type of data, and a transmission module for transmitting the first synchronized at least one type of data over a network. The plurality of detailed modules may include a reception module for receiving the transmitted at least one type of data over the network by the receiving device, a decoding module for decoding the received at least one type of data, a second synchronization module for second synchronizing the decoded at least one type of data, and a service module for providing the second synchronized at least one type of data to the user.

Herein, each of the encoding module and the first synchronization module of the providing device is an optional module, and the plurality of detailed modules may include the encoding module and the first synchronization module as needed. Further, each of the decoding module and the second synchronization module of the receiving device is also an optional module, and the plurality of detailed modules may include the decoding module and the second synchronization module as needed.

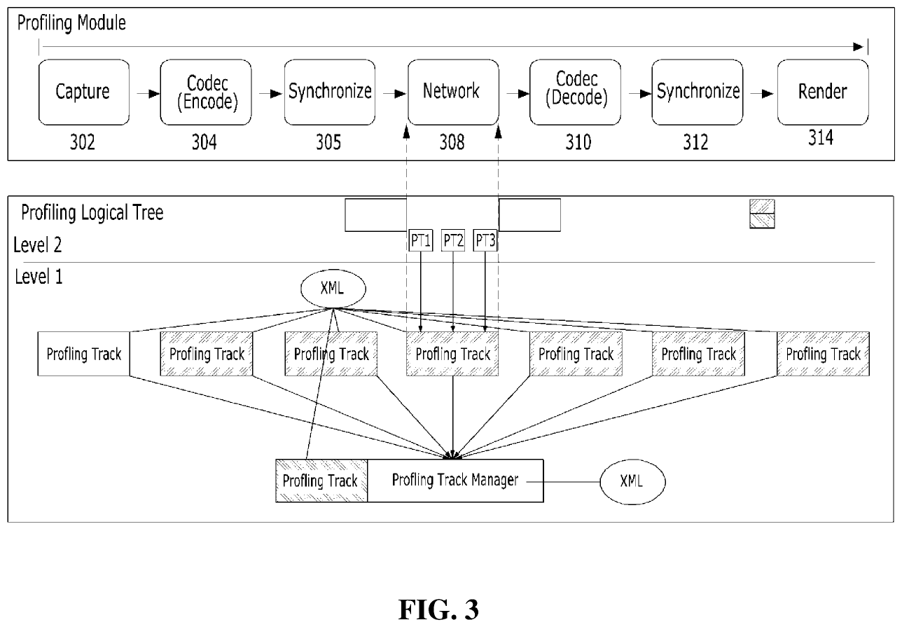

Referring to FIG. 3, the plurality of detailed modules may include a capture module 302, an encoding module 304, a first synchronization module 306, a network module 308, a decoding module 310, a second synchronization module 312 and a service module 314.

Here, the capture module 302, the encoding module 304, the first synchronization module 306, and the transmission module (not illustrated) operate inside the providing device, and the reception module (not illustrated), the decoding module 310, the second synchronization module 312 and the service module 314 may operate inside the receiving device.

Meanwhile, the network module 308 may not be a module that actually operates and the latency of the network module 308 may be calculated from a transmission time PT1 of the transmission module and a reception time PT3 of the reception module.

Finally, in step S130, the apparatus for operating the dynamic network service changes a configuration relating to at least one of the plurality of detailed modules so as to correspond to the required latency, on the basis of the profiling result thereof.

That is, the apparatus for operating the dynamic network service may determine whether the service may be provided to the user in accordance with the required latency using the profiling result thereof. Further, if the total latency is out of the latency range of the required latency due to the profiling result of a specific detailed module, the apparatus for operating the dynamic network service may change dynamically the configuration for the specific detailed module, which is at least one of the plurality of detailed modules, and operate.

For example, when at least one of the profiling results of the detailed module exceeds the latency range of the required latency, the apparatus for operating the dynamic network service may change the configuration to shorten the latency of the corresponding detailed module.

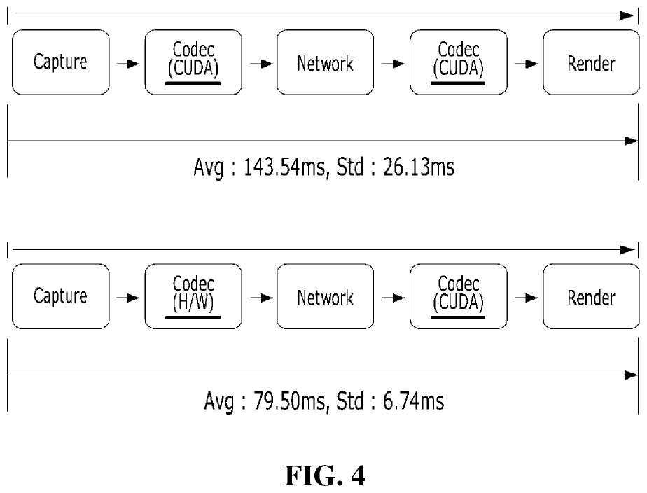

More specifically, referring to FIG. 4, when the configuration is changed to use a CUDA codec and then use an H/W codec during encoding and decoding, it is confirmed that the total latency of the detailed module is reduced from 143.54 ms to 79.50 ms. As such, the apparatus for operating the dynamic network service may change the codec to be used for encoding and decoding to shorten the latency.

Further, when at least one of the profiling results of the detailed module is beyond the latency range of the required latency, the apparatus for operating the dynamic network service may change the configuration to increase the latency of the corresponding detailed module.

As such, the apparatus for operating the dynamic network service may adjust the latency by changing the configuration in various ways with respect to the plurality of detailed modules.

In other exemplary embodiment, when the apparatus for operating the dynamic network service changes a configuration relating to at least one of the plurality of detailed modules, the apparatus for operating the dynamic network service may change a configuration for at least one of a data capture cycle of the capture module and a size of the captured data in association with the latencies of the transmission module and the reception module, change a configuration for at least one of a codec type, a loss, a resolution, a frame rate, and a bit rate in association with the latencies of the encoding module and the decoding module, or change a configuration for at least one of a delay, a time compensation cycle, and an output cycle in association with the latencies of the first synchronization module and the second synchronization module.

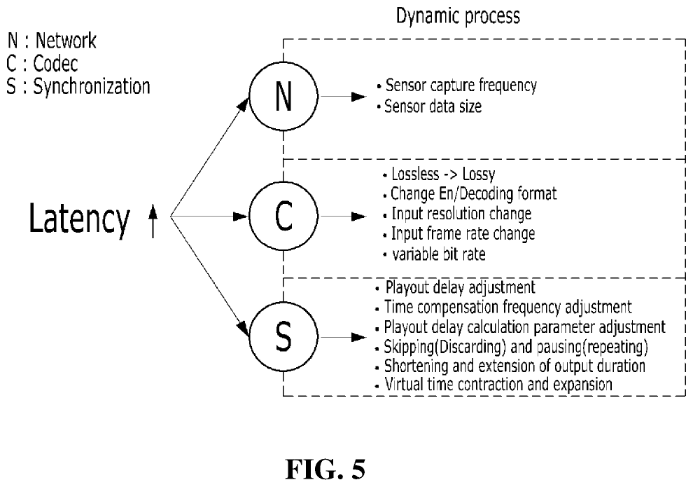

For example, referring to FIG. 5, the apparatus for operating the dynamic network service may change a configuration for at least one of a data capture cycle of the capture module and a size of the captured data in order to increase or shorten the latencies of the transmission module and the reception module. Further, referring to FIG. 5, the apparatus for operating the dynamic network service may change a configuration for at least one of a codec type, a loss, an input resolution, an input frame rate, and a variable bit rate in order to increase or shorten the latencies of the encoding module and the decoding module. Further, referring to FIG. 5, the apparatus for operating the dynamic network service may change a configuration for at least one of a playback delay, a time compensation cycle, a playback delay calculation parameter, discard/stop, shortening/increasing of an output cycle, and reducing/expanding of a virtual time in order to increase or shorten the latencies of the first synchronization module and the second synchronization module.

As described above, according to the method for operating the dynamic network service on the basis of the latency according to an exemplary embodiment of the present disclosure, it is possible to dynamically determine and operate the configuration each detailed module so as to correspond to latency requirements of the network service to be provided by profiling the latency of the detailed modules to be used in a network service using media data.

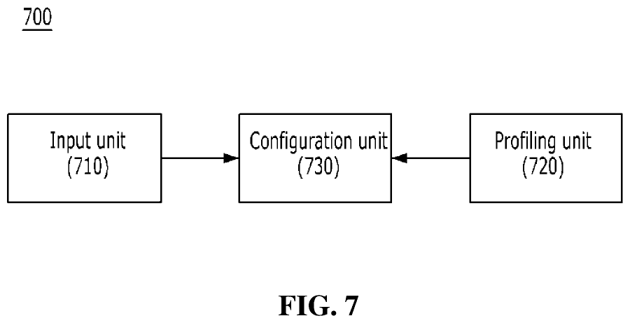

FIG. 7 is a block view for describing an apparatus for operating a dynamic network service on the basis of latency according to an exemplary embodiment of the present disclosure.

Referring to FIG. 7, an apparatus 700 for operating a dynamic network service on the basis of latency according to an exemplary embodiment of the present disclosure includes an input unit 710, a profiling unit 720, and a configuration unit 730.

Meanwhile, the apparatus 700 operating the dynamic network service on the basis of the latency according to the exemplary embodiment of the present disclosure may be installed in a computer, a smart phone, a tablet, a server computer, and the like, to operate in connection with other devices (for example, providing device, receiving device) to be used for operating the service through a wired/wireless network. Alternatively, the apparatus 700 operating the dynamic network service on the basis of the latency according to the exemplary embodiment of the present disclosure may be installed in the providing device or the receiving device to operate.

The input unit 710 receives a required latency corresponding to latency required for operating a service in which at least one of video data, voice data, and sensor data is provided to the user over the network.

The profiling unit 720 profiles latency information, which is information on a latency associated with each of the plurality of detailed modules used for operating the service while the service is operating.

The configuration unit 730 changes a configuration for at least one of the plurality of detailed modules to correspond to the required latency, on the basis of the profiling result thereof.

In another exemplary embodiment, the service may be performed by collecting at least one type of data and transmitting the collected data over the network in a providing device and receiving at least one piece of the transmitted data to provide the received data to the user in a receiving device.

In yet another exemplary embodiment, the plurality of detailed modules may be configured so that the providing device includes a capture module for capturing the at least one type of data and a transmission module for transmitting the captured at least one type of data over the network, and the receiving device includes a reception module for receiving the transmitted at least one type of data over the network, and a service module for providing the received at least one type of data to the user.

In still another exemplary embodiment, the plurality of detailed modules may be configured so that the providing device includes a capture module for capturing the at least one type of data, an encoding module for encoding the captured at least one type of data, and a transmission module for transmitting the encoded at least one type of data over the network, and the receiving device includes a reception module for receiving the transmitted at least one type of data over the network, a decoding module for decoding the received at least one type of data, and a service module for providing the decoded at least one type of data to the user.

In still yet another exemplary embodiment, the plurality of detailed modules may be configured so that the providing device includes a capture module for capturing at least one type of data, a first synchronization module for first synchronizing the captured at least one type of data, and a transmission module for transmitting the first synchronized at least one type of data over a network, and the receiving device includes a reception module for receiving the transmitted at least one type of data over the network, a second synchronization module for second synchronizing the received at least one type of data, and a service module for providing the second synchronized at least one type of data to the user.

In still yet another exemplary embodiment, the plurality of detailed modules may be configured so that the providing device includes a capture module for capturing at least one type of data, an encoding module for encoding the captured at least one type of data, a first synchronization module for first synchronizing the encoded at least one type of data, and a transmission module for transmitting the first synchronized at least one type of data over a network, and the receiving device includes a reception module for receiving the transmitted at least one type of data over the network, a decoding module for decoding the received at least one type of data, a second synchronization module for second synchronizing the decoded at least one type of data, and a service module for providing the second synchronized at least one type of data to the user.

In other exemplary embodiment, the configuration unit 730 may change a configuration for at least one of a data capture cycle of the capture module and a size of the captured data in association with the latencies of the transmission module and the reception module, change a configuration for at least one of a codec type, a loss, a resolution, a frame rate, and a bit rate in association with the latencies of the encoding module and the decoding module, or change a configuration for at least one of a delay, a time compensation cycle, and an output cycle in association with the latencies of the first synchronization module and the second synchronization module.

In yet another exemplary embodiment, the sensor data may include at least one of 3D modeling data, haptic data, motion data, and physical data.

The exemplary embodiments of the present disclosure described above may be prepared by a computer executable program and implemented by a universal digital computer which operates the program by using a computer readable recording medium.

The computer readable recording medium includes magnetic storage media (for example, a ROM, a floppy disk, a hard disk, and the like) and optical reading media (for example, a CD-ROM, a DVD, and the like).

The present disclosure has been described above with reference to preferred embodiments thereof. It is understood to those skilled in the art that the present disclosure may be implemented as a modified form without departing from an essential characteristic of the present disclosure. Therefore, the disclosed embodiments should be considered in an illustrative viewpoint rather than a restrictive viewpoint. The scope of the present disclosure is defined by the appended claims rather than by the foregoing description, and all differences within the scope of equivalents thereof should be construed as being included in the present disclosure.

What is claimed is:

1. A method for operating a dynamic network service on the basis of latency, the method comprising:
receiving a required latency corresponding to a latency required for operating a service in which at least one type of data among video data, voice data, and sensor data is provided to a user over a network;
profiling latency information which is information on a latency related to each of a plurality of detailed modules to be used for operating the service while the service is operating; and
changing a configuration for at least one of the plurality of detailed modules so as to correspond to the required latency on the basis of the profiling result.

2. The method for operating a dynamic network service on the basis of the latency of claim 1, wherein the service is performed by collecting the at least one type of data to transmit the collected data over the network in a providing device, and receiving at least one piece of the transmitted data to provide the received data to the user in a receiving device.

3. The method for operating a dynamic network service on the basis of latency of claim 2, wherein the plurality of detailed modules are configured by at least one of
a capture module for capturing the at least one type of data and a transmission module for transmitting the captured at least one type of data over the network, a reception module for receiving the transmitted at least one type of data over the network, and a service module for providing the received at least one type of data to the user.

4. The method for operating a dynamic network service on the basis of the latency of claim 2, wherein the plurality of detailed modules are configured by at least one of a capture module for capturing the at least one type of data, an encoding module for encoding the captured at least one type of data, and a transmission module for transmitting the encoded at least one type of data over the network, a reception module for receiving the transmitted at least one type of data over the network, a decoding module for decoding the received at least one type of data, and a service module for providing the decoded at least one type of data to the user.

5. The method for operating a dynamic network service on the basis of the latency of claim 2, wherein the plurality of detailed modules are configured by at least one of a capture module for capturing at least one type of data, a first synchronization module for first synchronizing the captured at least one type of data, and a transmission module for transmitting the first synchronized at least one type of data over a network, a reception module for receiving the transmitted at least one type of data over the network, a second synchronization module for second synchronizing the received at least one type of data, and a service module for providing the second synchronized at least one type of data to the user.

6. The method for operating a dynamic network service on the basis of the latency of claim 2, wherein the plurality of detailed modules are configured by at least one of a capture module for capturing at least one type of data, an encoding module for encoding the captured at least one type of data, a first synchronization module for first synchronizing the encoded at least one type of data, and a transmission module for transmitting the first synchronized at least one type of data over a network,
a reception module for receiving the transmitted at least one type of data over the network, a decoding module for decoding the received at least one type of data, a second synchronization module for second synchronizing the decoded at least one type of data, and a service module for providing the second synchronized at least one type of data to the user.

7. The method for operating a dynamic network service on the basis of the latency of claim 3, wherein in the changing of the configuration for at least one of the plurality of detailed modules, a configuration for at least one of a data capture cycle of the capture module and a size of the captured data is changed in association with the latencies of the transmission module and the reception module.

8. The method for operating a dynamic network service on the basis of the latency of claim 4, wherein in the changing of the configuration for at least one of the plurality of detailed modules, a configuration for at least one of a codec type, a loss, a resolution, a frame rate, and a bit rate is changed in association with the latencies of the encoding module and the decoding module.

9. The method for operating a dynamic network service on the basis of the latency of claim 5, wherein in the changing of the configuration for at least one of the plurality of detailed modules, a configuration for at least one of a delay, a time compensation cycle, and an output cycle is changed in association with the latencies of the first synchronization module and the second synchronization module.

10. The method for operating a dynamic network service on the basis of the latency of claim 1, wherein the sensor data includes at least one of 3D modeling data, haptic data, motion data, and physical data.

11. An apparatus for operating a dynamic network service on the basis of latency, the apparatus comprising:
an input unit configured to receive a required latency corresponding to a latency required for operating a service in which at least one type of data among video data, voice data, and sensor data is provided to a user over a network;
a profiling unit configured to profile latency information which is information on a latency related to each of a plurality of detailed module to be used for operating the service while the service is operating; and
a configuration unit configured to change a configuration for at least one of the plurality of detailed modules so as to correspond to the required latency on the basis of the profiling result.

12. The apparatus for operating a dynamic network service on the basis of latency of claim 11, wherein the service is performed by collecting the at least one type of data to transmit the collected data over the network in a providing device, and receiving at least one piece of the transmitted data to provide the received data to the user in a receiving device.

13. The apparatus for operating a dynamic network service on the basis of latency of claim 12, wherein the plurality of detailed modules are configured by at least one of a capture module for capturing the at least one type of data and a transmission module for transmitting the captured at least one type of data over the network,
a reception module for receiving the transmitted at least one type of data over the network, and a service module for providing the received at least one type of data to the user.

14. The apparatus for operating a dynamic network service on the basis of the latency of claim 12, wherein the plurality of detailed modules are configured by at least one of a capture module for capturing the at least one type of data, an encoding module for encoding the captured at least one type of data, and a transmission module for transmitting the encoded at least one type of data over the network,
a reception module for receiving the transmitted at least one type of data over the network, a decoding module for decoding the received at least one type of data, and a service module for providing the decoded at least one type of data to the user.

15. The apparatus for operating a dynamic network service on the basis of latency of claim 12, wherein the plurality of detailed modules are configured by at least one of a capture module for capturing at least one type of data, a first synchronization module for first synchronizing the captured at least one type of data, and a transmission module for transmitting the first synchronized at least one type of data over a network,
a reception module for receiving the transmitted at least one type of data over the network, a second synchronization module for second synchronizing the received at least one type of data, and a service module for providing the second synchronized at least one type of data to the user.

16. The apparatus for operating a dynamic network service on the basis of latency of claim 12, wherein the plurality of detailed modules are configured by at least one of a capture module for capturing at least one type of data, an encoding module for encoding the captured at least one type of data, a first synchronization module for first synchronizing the encoded at least one type of data, and a transmission module for transmitting the first synchronized at least one type of data over a network,
a reception module for receiving the transmitted at least one type of data over the network e, a decoding module for decoding the received at least one type of data, a second synchronization module for second synchronizing the decoded at least one type of data, and a service module for providing the second synchronized at least one type of data to the user.

17. The apparatus for operating a dynamic network service on the basis of the latency of claim 13, wherein the configuration unit changes a configuration for at least one of a data capture cycle of the capture module and a size of the captured data in association with the latencies of the transmission module and the reception module.

18. The apparatus for operating a dynamic network service on the basis of latency of claim 14, wherein the configuration unit changes a configuration for at least one of a codec type, a loss, a resolution, a frame rate, and a bit rate in association with the latencies of the encoding module and the decoding module.

19. The apparatus for operating a dynamic network service on the basis of the latency of claim 15, wherein the configuration unit changes a configuration for at least one of a delay, a time compensation cycle, and an output cycle in association with the latencies of the first synchronization module and the second synchronization module.

20. The apparatus for operating a dynamic network service on the basis of the latency of claim 11, wherein the sensor data includes at least one of 3D modeling data, haptic data, motion data, and physical data.
